(19) United States
(12) Patent Application Publication
(10) Pub. No.: US 2024/0206545 A1
(43) Pub. Date: Jun. 27, 2024

(54) HEATING ASSEMBLY AND AEROSOL-GENERATING DEVICE

(71) Applicant: SHENZHEN FIRST UNION TECHNOLOGY CO., LTD., Shenzhen, Guangdong Province (CN)

(72) Inventors: Supeng KUAI, Shenzhen, Guangdong Province (CN); Zhongli XU, Shenzhen, Guangdong Province (CN); Yonghai LI, Shenzhen, Guangdong Province (CN)

(73) Assignee: SHENZHEN FIRST UNION TECHNOLOGY CO., LTD., Shenzhen, Guangdong Province (CN)

(21) Appl. No.: 18/291,350

(22) PCT Filed: Aug. 2, 2022
(86) PCT No.: PCT/CN2022/109777

§ 371 Date: Jan. 23, 2024

(30) Foreign Application Priority Data
Aug. 2, 2021 (CN) 202110879455.5
Aug. 2, 2021 (CN) 2021108828447.7

(51) Int. Cl. A24F 40/465; A24F 40/51; H05B 6/06; H05B 6/10

(52) U.S. Cl. CPC A24F 40/465; A24F 40/51; H05B 6/06; H05B 6/105; H05B 2213/07

(57) ABSTRACT

Provided are a heating assembly and an aerosol-generation device. The heating assembly is detachably disposed on the aerosol-generation device; and the heating assembly includes: a susceptor, configured to be penetrated by a changing magnetic field to generate heat, to heat an aerosol-generation product, a keeping member, configured to keep the susceptor, and a first electrical connector, one end being configured to be electrically connected to a power supply assembly in the aerosol-generation device, and an other end being configured to be electrically connected to a magnetic field generator in the aerosol-generation device. The heating assembly is detachably disposed on the aerosol-generation device. The heating assembly is detachably disposed on the aerosol-generation device, which facilitates cleaning or replacement of the heating assembly.

### CROSS-REFERENCE TO RELATED APPLICATIONS

This application claims priority to Chinese Patent Application No. 202110882847.7, entitled “HEATING ASSEMBLY AND AEROSOL-GENERATION DEVICE” filed with the China National Intellectual Property Administration on Aug. 2, 2021, which is incorporated herein by reference in its entirety.

This application claims priority to Chinese Patent Application No. 202110879455.5, entitled “HEATER AND AEROSOL-GENERATION DEVICE” filed with the China National Intellectual Property Administration on Aug. 2, 2021, which is incorporated herein by reference in its entirety.

### TECHNICAL FIELD

This application relates to the field of cigarette device technologies, and in particular, to a heating assembly and an aerosol-generation device.

### BACKGROUND

During use of smoking items such as cigarettes and cigars, tobacco is burnt to generate smoke. Attempts have been made to provide substitutes for these tobacco-burning items by producing products that release compounds without burning. An example of such a product is a so-called heat-not-burn product which releases compounds by heating instead of burning tobacco.

An existing aerosol-generation device is provided with a susceptor that can be inserted into an aerosol-generation product. The susceptor is configured to be penetrated by a changing magnetic field to generate heat, thereby heating the aerosol-generation product to generate an inhalable aerosol.

The susceptor part in the aerosol-generation device is usually disposed in a cavity formed by a magnetic field generator, resulting in a complicated structural design and inconvenient mounting and disassembly.

### SUMMARY

This application provides a heating assembly and an aerosol-generation device, which can make a susceptor part easy to clean or replace.

According to a first aspect, an embodiment of this application provides a heating assembly. The heating assembly is detachably disposed on an aerosol-generation device; and the heating assembly includes:

a susceptor, configured to be penetrated by a changing magnetic field to generate heat, to heat an aerosol-generation product;

a keeping member, configured to keep the susceptor; and

a first electrical connector, where one end is configured to be electrically connected to a power supply assembly in the aerosol-generation device, and an other end is configured to be electrically connected to a magnetic field generator in the aerosol-generation device.

In some embodiments, the first electrical connector is disposed in the keeping member.

In some embodiments, the keeping member has a first surface and a second surface opposite to the first surface; and the end of the electrical connector is exposed on the first surface, and the other end is exposed on the second surface.

In some embodiments, the keeping member includes a base and a fixing base that are detachably connected; and the base is fixedly connected to the susceptor, and the fixing base is configured to keep the base.

In some embodiments, the base is buckled to the fixing base.

In some embodiments, a temperature measuring element and a second electrical connector are further included, where the temperature measuring element is configured to sense temperature information of the susceptor; and the end of the second electrical connector is electrically connected to the temperature measuring element, and the other end is configured to be electrically connected to the power supply assembly in the aerosol-generation device.

In some embodiments, the temperature measuring element is at least partially disposed in the susceptor.

According to a second aspect, an embodiment of this application further provides an aerosol-generation device, including:

a power supply assembly, including a first housing, where the power supply assembly is configured to supply power;

a magnetic field generator, configured to generate a changing magnetic field; and

the heating assembly.

In some embodiments, a holder is further included and is configured to hold the magnetic field generator, where the holder is detachably connected to the keeping member.

In some embodiments, a third electrical connector disposed on the holder is further included, where one end of the third electrical connector is electrically connected to the magnetic field generator; and when the holder is connected to the keeping member, an other end is configured to be in contact with the first electrical connector to form an electrical connection.

In some embodiments, the holder includes an inner cylinder and an outer cylinder, and the magnetic field generator is kept between the inner cylinder and the outer cylinder.

In some embodiments, the inner cylinder is detachably connected to the outer cylinder.

In some embodiments, an inner wall of the outer cylinder is provided with a groove, and an outer wall of the inner cylinder has a first convex buckle snap-fitted to the groove.

In some embodiments, the first convex buckle is a cantilever formed on the outer wall of the inner cylinder.

In some embodiments, an axial extension length of the outer cylinder is greater than an axial extension length of the inner cylinder, to form an accommodating chamber between an end portion of the outer cylinder and an end portion of the inner cylinder; and when the keeping member is connected to the holder, at least part of the keeping member is accommodated in the accommodating chamber.

In some embodiments, the keeping member is detachably connected to the outer cylinder.

In some embodiments, the inner wall of the outer cylinder is provided with a first engagement hole, and an outer wall of the keeping member has a second convex buckle snap-fitted to the first engagement hole.

In some embodiments, an extractor configured to extract the aerosol-generation product received in a heating chamber is further included, where the extractor is detachably connected to the holder.

In some embodiments, a second housing that is detachably connected to the holder and the extractor is further included.

In some embodiments, a first anti-mistaken disassembly structure is further included, where the second housing is detachably connected to the extractor and the holder through the first anti-mistaken disassembly structure.

In some embodiments, the holder is detachably connected to the first housing.

In some embodiments, a second anti-mistaken disassembly structure is further included, where the holder is detachably connected to the first housing through the second anti-mistaken disassembly structure.

In some embodiments, the first housing includes an accommodating chamber with an open end portion, configured to accommodate at least part of the heating assembly.

In some embodiments, a clamping portion is disposed inside the first housing; and the heating assembly has an interface, configured to be screw-locked with the clamping portion.

In some embodiments, the first housing is provided with a second engagement hole; and the heating assembly has an elastic arm, configured to be buckled to the second engagement hole.

In some embodiments, a moving member is further included and is configured to move toward the elastic arm under the action of an external force, to disengage the elastic arm from the second engagement hole.

In some embodiments, an elastic member connected to the moving member is further included, where the elastic member is configured to generate a repulsive force under the action of the external force, so that the moving member returns to an initial position.

In some embodiments, the power supply assembly includes a fourth electrical connector, configured to be electrically connected to the heating assembly.

According to a third aspect, an embodiment of this application further provides a method for an aerosol-generation device, the aerosol-generation device including a first assembly structure and the heating assembly, where the heating assembly has a second assembly structure matching the first assembly structure, the method includes:

disconnecting the second assembly structure from the first assembly structure to remove the heating assembly from the aerosol-generation device;

cleaning the removed heating assembly; and

connecting the first assembly structure to the second assembly structure, to assemble the cleaned heating assembly to the aerosol-generation device.

According to a fourth aspect, an embodiment of this application further provides a method for an aerosol-generation device, the aerosol-generation device including a first assembly structure and the heating assembly, where there are two heating assemblies, namely, a first heating assembly and a second heating assembly, where the first heating assembly and the second heating assembly each include a second assembly structure matching the first assembly structure, the method includes:

disconnecting the second assembly structure of the first heating assembly from the first assembly structure to remove the first heating assembly from the aerosol-generation device; and

connecting the second assembly structure of the second heating assembly to the first assembly structure, to assemble the second heating assembly to the aerosol-generation device.

In the heating assembly and the aerosol-generation device provided in the embodiments of this application, the heating assembly is detachably disposed on the aerosol-generation device, which facilitates cleaning or replacement of the heating assembly.

### BRIEF DESCRIPTION OF THE DRAWINGS

One or more embodiments are exemplarily described with reference to the corresponding figures in the accompanying drawings, and the exemplary descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic diagram of an aerosol-generation device and an aerosol-generation product according to an implementation of this application;

FIG. 2 is a schematic diagram of an aerosol-generation device according to an implementation of this application;

FIG. 3 is a schematic exploded view of an aerosol-generation device according to an implementation of this application;

FIG. 4 is a schematic sectional view of an aerosol-generation device according to an implementation of this application;

FIG. 5 is a schematic exploded view of a heating assembly according to an implementation of this application;

FIG. 6 is a schematic sectional view of a holder and a magnetic field generator according to an implementation of this application;

FIG. 7 is a schematic sectional view of an outer cylinder according to an implementation of this application;

FIG. 8 is a schematic diagram of an inner cylinder according to an implementation of this application;

FIG. 9 is a schematic diagram of a susceptor and a keeping member from another perspective according to an implementation of this application;

FIG. 10 is a schematic diagram of a voltage assembly according to an implementation of this application;

FIG. 11 is a schematic diagram of another aerosol-generation device according to an implementation of this application;

FIG. 12 to FIG. 15 are schematic diagrams of an anti-mistaken disassembly structure according to an implementation of this application;

FIG. 16 to FIG. 18 are schematic diagrams of another anti-mistaken disassembly structure according to an implementation of this application;

FIG. 19 and FIG. 20 are schematic diagrams of still another anti-mistaken disassembly structure according to an implementation of this application;

FIG. 21 is a schematic flowchart of a method for an aerosol-generation device according to an implementation of this application; and

FIG. 22 is a schematic flowchart of another method for an aerosol-generation device according to an implementation of this application.

### DETAILED DESCRIPTION

For ease of understanding of this application, this application is described below in more detail with reference to the accompanying drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the technical field to which this application belongs. The terms used in this specification of this application are merely intended to describe objectives of the specific implementations, and are not intended to limit this application. The term “and/or” used in this specification includes any or all combinations of one or more related listed items.

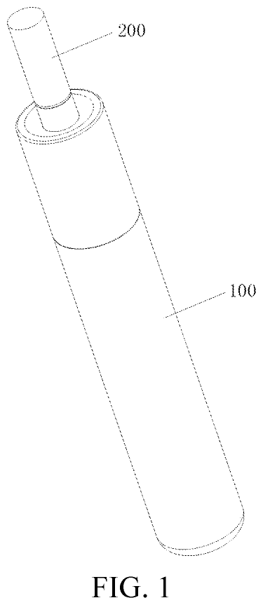

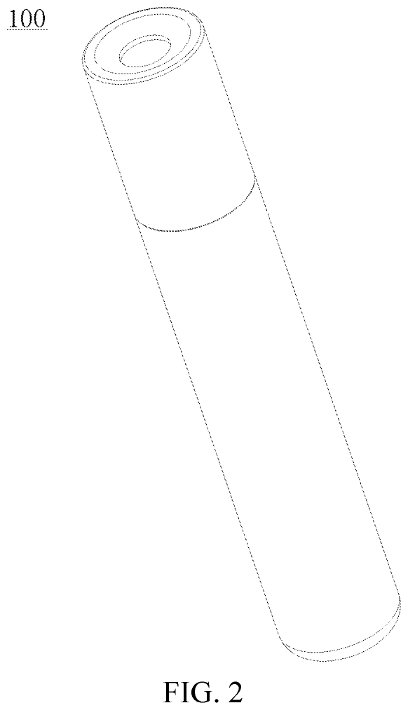

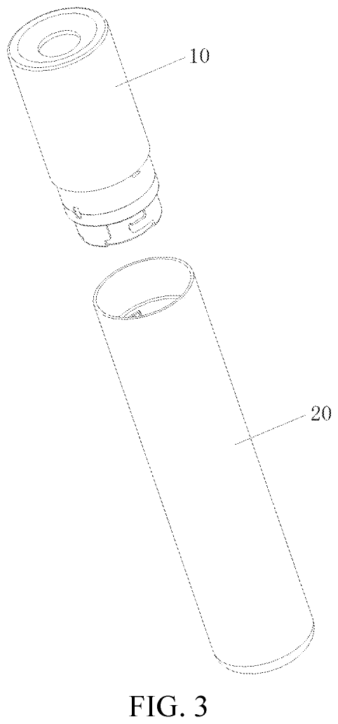

As shown in FIG. 1 to FIG. 3, an aerosol-generation device 100 provided in a first embodiment of this application includes a heating assembly 10 and a power supply assembly 20. The heating assembly 10 and the power supply assembly 20 are detachably connected.

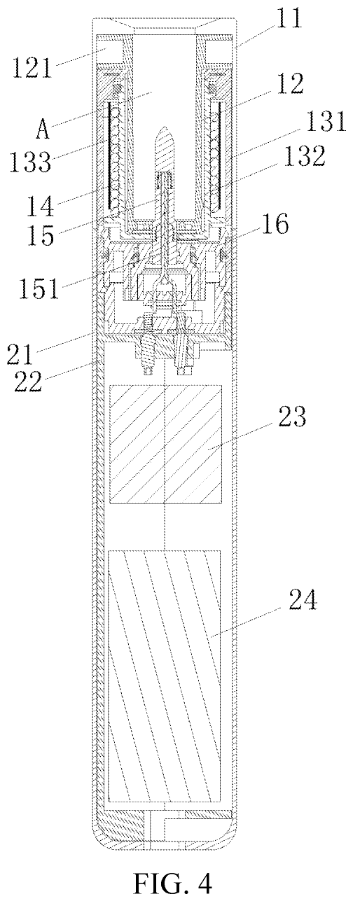

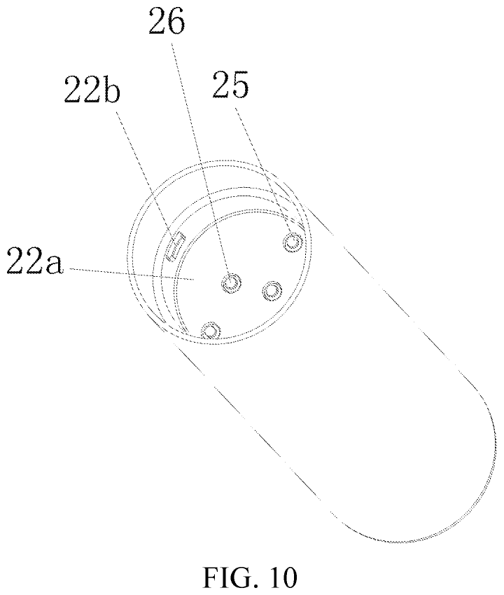

Refer to FIG. 4 and FIG. 10. It can be understood that the power supply assembly 20 includes a first housing 21 that is substantially tubular, and a support member 22, a circuit 23, a battery core 24, a fourth electrical connector 25, and a fifth electrical connector 26 that are disposed in the first housing 21.

The support member 22 includes an accommodating chamber 22a with an open end portion. When the heating assembly 10 is connected to the power supply assembly 20, at least part of the heating assembly 10 is accommodated in the accommodating chamber 22a. A clamping portion 22b is disposed inside the accommodating chamber 22a, and the clamping portion 22b is a bump formed on an inner wall of the support member 22. One end of the fourth electrical connector 25 and one end of the fifth electrical connector 26 are electrically connected to the battery core 24, and an other end of the fourth electrical connector 25 and an other end of the fifth electrical connector 26 are exposed in the accommodating chamber 22a.

The circuit 23 is configured for overall control of the aerosol-generation device 100.

The battery core 24 is configured to supply power. In a preferred implementation, the battery core 24 is a rechargeable battery core.

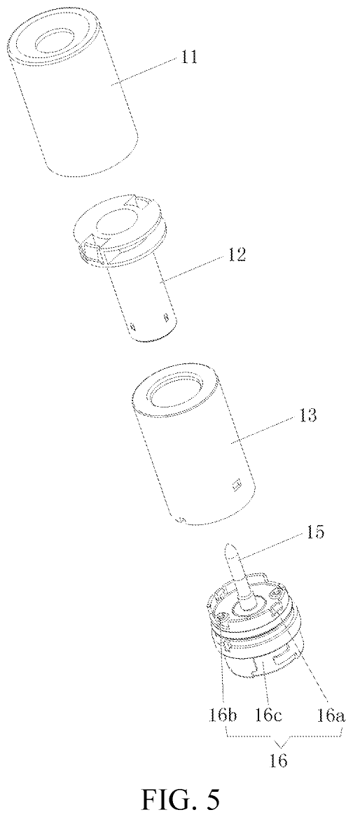

As shown in FIG. 4 and FIG. 5, the heating assembly 10 includes a second housing 11, an extractor 12, a holder 13, a magnetic field generator 14, a susceptor 15, and a keeping member 16.

A heating chamber A is configured to removably receive an aerosol-generation product 200.

The magnetic field generator 14, such as an inductor coil L, is configured to generate a changing magnetic field.

The susceptor 15 at least partially extends in the heating chamber A, is configured to be inductively coupled to the inductor coil L, and generates heat when penetrated by the changing magnetic field, thereby heating the aerosol-generation product 200, so that at least one component of the aerosol-generation product 200 is volatilized to form an aerosol for inhalation.

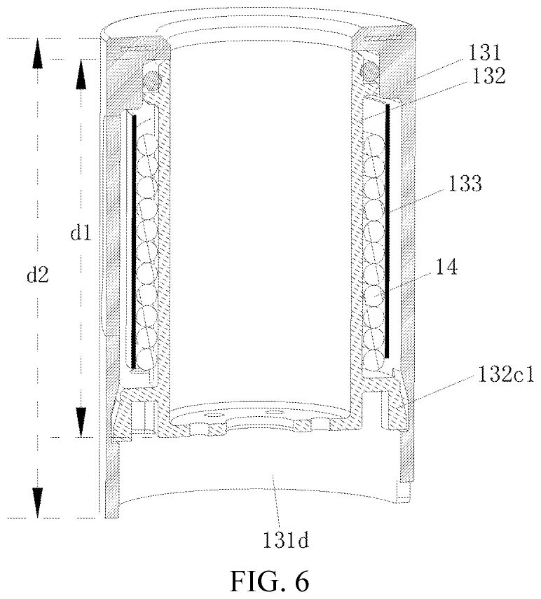

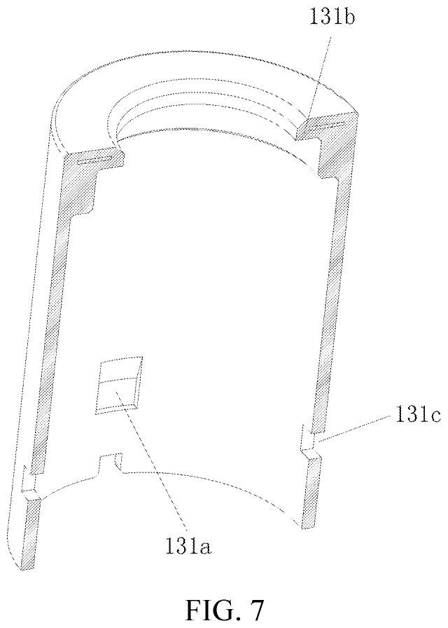

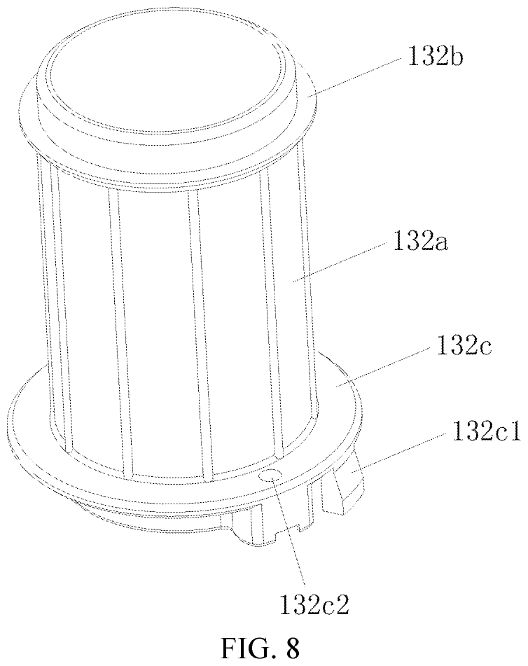

Refer to FIG. 6 to FIG. 8. It can be understood that the holder 13 includes an outer cylinder 131 and an inner cylinder 132. The outer cylinder 131 and the inner cylinder 132 are detachably connected.

Both the outer cylinder 131 and the inner cylinder 132 extend in an axial direction of the heating chamber A and are substantially tubular.

An inner wall of the outer cylinder 131 is provided with a groove 131a and a first engagement hole 131c. An extending portion 131b extends radially from an upper end of the outer cylinder 131.

The inner cylinder 132 includes a tubular body 132a; an extending portion 132b and an extending portion 132c extending radially from the body 132a toward the outer cylinder 131, where the extending portion 132b and the extending portion 132c are respectively disposed close to two ends of the body 132a; and a cantilever 132cl and a through hole 132c2 formed on the extending portion 132c.

When the outer cylinder 131 is sleeved on the inner cylinder 132, an upper end of the body 132a abuts against the extending portion 131b, and the extending portion 132b abuts against the inner wall of the outer cylinder 131. The extending portion 132c is also in contact with the inner wall of the outer cylinder 131. In this way, a substantially sealed space is formed between the extending portion 132b, the extending portion 132c, an outer wall of the body 132a, and the inner wall of the outer cylinder 131, and the magnetic field generator 14 is kept in the sealed space.

Further, a sealing member may be disposed on the outer wall of the body 132a and the inner wall of the outer cylinder 131 for sealing, and the sealing member may be disposed on the extending portion 132b.

Further, a magnetic field shield 133 is further disposed between the magnetic field generator 14 and the outer cylinder 131 to isolate the outer cylinder 131 (or another component) from the changing magnetic field to prevent the outer cylinder 131 from being penetrated by the changing magnetic field and generating heat.

The cantilever 132cl is buckled to the groove 131a, so that the outer cylinder 131 is kept on the inner cylinder 132 and is detachable from the inner cylinder 132. It should be noted that, a structural member that is buckled to the groove 131a is not limited to the cantilever 132cl, and may alternatively be a first convex buckle 132cl formed on the extending portion 132c or the body 132a.

The keeping member 16 is configured to keep an end of the susceptor 15. The keeping member 16 may be formed separately by a plurality of structural members. Specifically, the keeping member 16 includes a base (not shown in the figure) and a fixing base (not shown in the figure) that are detachably connected. The base is fixedly connected to the susceptor 15, and the fixing base is buckled to the base and is configured to keep the base.

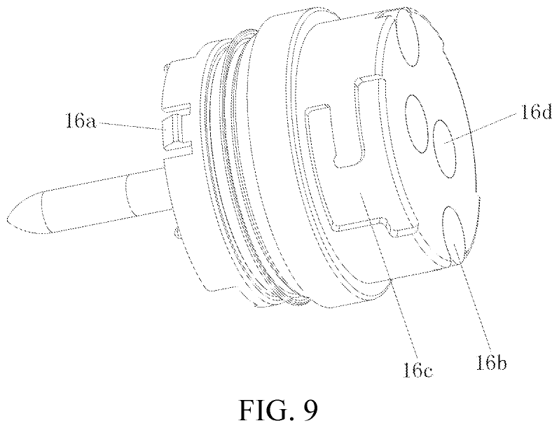

Refer to FIG. 9. It can be understood that an axial extension length d2 of the outer cylinder 131 is greater than an axial extension length d1 of the inner cylinder 132, so that an accommodating chamber 131d is formed between a lower end of the outer cylinder 131 and a lower end of the inner cylinder 132. An outer wall of the keeping member 16 has a second convex buckle 16a that is buckled to the first engagement hole 131c, so that the keeping member 16 is detachably connected to the outer cylinder 131. When the keeping member 16 is connected to the outer cylinder 131 of the holder 13, part of the keeping member 16 is accommodated in the accommodating chamber 131d.

When the heating assembly 10 is connected to the power supply assembly 20, part of the keeping member 16 is accommodated in the accommodating chamber 22a. The keeping member 16 is detachably connected to the support member 22. Specifically, the outer wall of the keeping member 16 has an interface 16c that is screw-locked with the clamping portion 22b. During assembly, the keeping member 16 is accommodated in the accommodating chamber 22a, and the interface 16c is misaligned with the clamping portion 22b, and then the heating assembly 10 or the power supply assembly 20 is rotated, so that the clamping portion 22b is buckled in the interface 16c; and just reverse it during disassembly.

The heating assembly 10 further includes a third electrical connector (not shown in the figure) disposed on the inner cylinder 132, and a first electrical connector 16b and a second electrical connector 16d disposed on the keeping member 16.

The third electrical connector is disposed in the through hole 132c2, one end is electrically connected to the magnetic field generator 14, and an other end is exposed at a lower end portion of the inner cylinder 132. The first electrical connector 16b is disposed in the keeping member 16. The keeping member 16 has an upper end surface and a lower end surface. One end of the first electrical connector 16b is exposed on the upper end surface of the keeping member 16, and an other end is exposed on the lower end surface of the keeping member 16.

When the keeping member 16 is connected to the outer cylinder 131, the other end of the third electrical connector is in contact with the end of the first electrical connector 16b to form an electrical connection. When the heating assembly 10 is connected to the power supply assembly 20, the other end of the first electrical connector 16b is in contact with an other end of the fourth electrical connector 25 to form an electrical connection.

The heating assembly 10 further includes a temperature measuring element 151 for sensing temperature information of the susceptor 15, and the temperature measuring element 151 is at least partially disposed in the susceptor 15. One end of the second electrical connector 16d is electrically connected to the temperature measuring element 151, and an other end of the second electrical connector 16d is exposed at a lower end portion of the keeping member 16.

When the heating assembly 10 is connected to the power supply assembly 20, the other end of the second electrical connector 16d is in contact with the other end of the fifth electrical connector 26 to form an electrical connection.

The extractor 12 is configured to extract an aerosol-generation product 200 received in a heating chamber A. The extractor 12 is configured in a tube shape extending in an axial direction of the heating chamber A, and a tubular hollow portion of the extractor forms the heating chamber A. When the extractor 12 does not extract the aerosol-generation product 200, an end thereof extends into the inner cylinder 132, and an other end is kept on the extending portion 131b of the outer cylinder 131. An other end of the susceptor 15 can pass through one end of the extractor 12 and is inserted into the aerosol-generation product 200 received in the heating chamber A.

Further, an outer wall of the extractor 12 is provided with a chamber 121 to accommodate a first magnetic member (not shown in the figure). A second magnetic member is disposed inside the outer cylinder 131. In this way, the first magnetic member matches the second magnetic member, so that the extractor 12 is kept on the outer cylinder 131 and is detachable from the outer cylinder 131.

The second housing 11 is sleeved on the outer cylinder 131 and the extractor 12, and the second housing 11 abuts against an end portion of the extractor 12. The second housing 11 can also be detached from the outer cylinder 131 and the extractor 12. As an example, an inner wall of the second housing 11 may be provided with a groove, and a convex buckle matching the groove may be disposed on the extractor 12 to achieve a buckling connection. The second housing 11 is flush with the first housing 21 of the power supply assembly 20, keeping the appearance neat and consistent. The second housing 11 is further provided with an opening. The aerosol-generation product 200 is removably received in the heating chamber A through the opening.

Refer to FIG. 11. Different from the examples in FIG. 1 to FIG. 10, in another example, the first housing 21 is provided with a second engagement hole inside. The heating assembly 10 has an elastic arm 10a, configured to be buckled to the second engagement hole. Further, a moving member 20a and an elastic member 20b connected to the moving member 20a are disposed in the second engagement hole. One end of the moving member 20a is exposed on a surface of the aerosol-generation device 100. In this way, under the action of an external force F, the moving member 20a can move toward the elastic arm 10a along the second engagement hole, so that the elastic arm 10a is disengaged from the second engagement hole, and the heating assembly 10 is detachable from the power supply assembly 20. The elastic member 20b generates a repulsive force under the action of the external force F. After the external force F is removed, the repulsive force may enable the moving member 20a to return to an initial position.

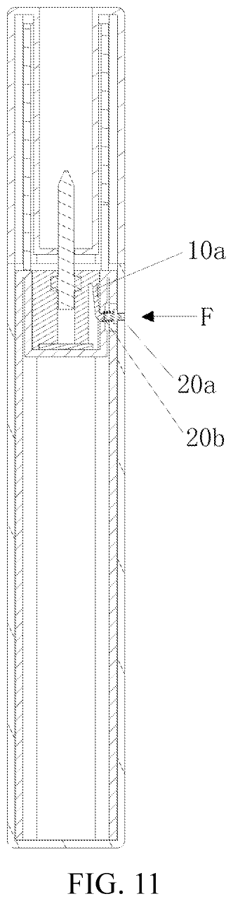

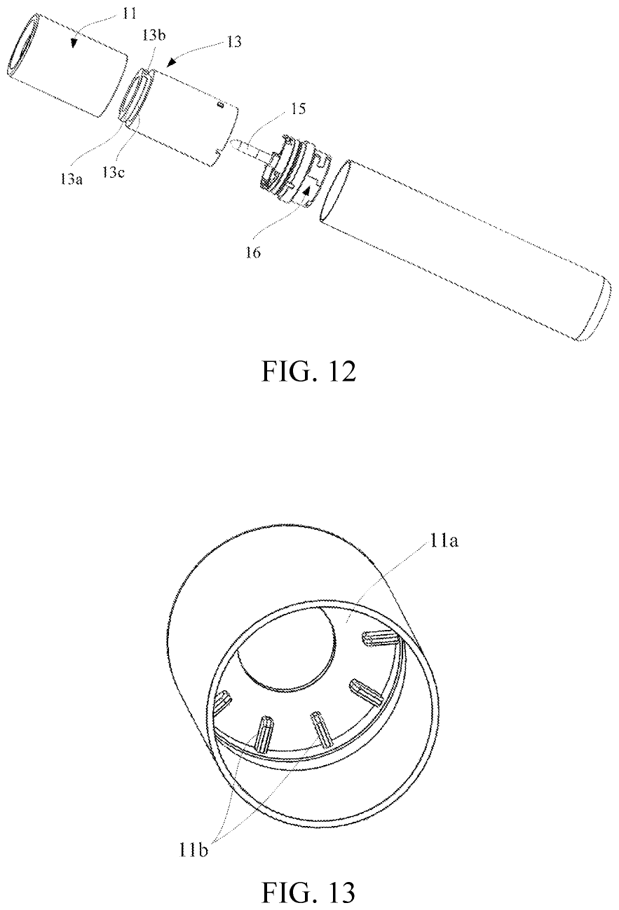

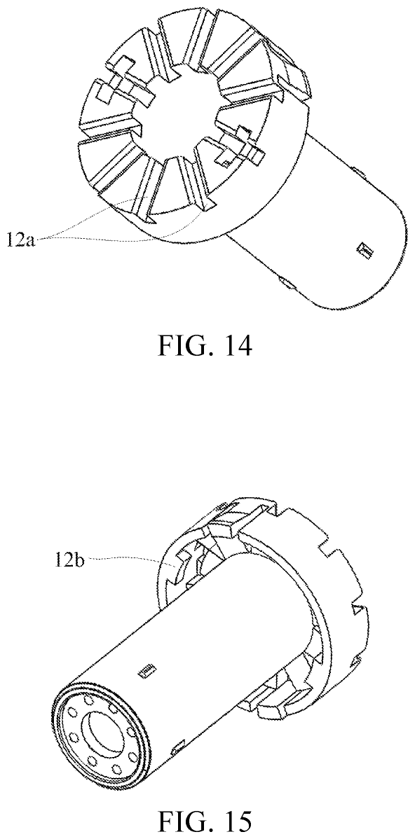

Then, refer to FIG. 12 to FIG. 15. In another example, the second housing 11 is detachably connected to the extractor 12 and the holder 13 through a first anti-mistaken disassembly structure. The holder 13 and the first housing 21 are detachably connected through a second anti-mistaken disassembly structure.

Specifically, the anti-mistaken disassembly structure includes an interference block 11b, and the interference block 11b is disposed on a lower side of a top board 11a of the second housing 11. For example, the interference block 11b may be a radially extending convex strip, and a quantity thereof may be one or more.

A top side of the extractor 12 is provided with an interference groove 12a, and a first block 12b is disposed on a bottom side. The part of the extractor 12 kept on the extending portion 131b of the outer cylinder 131 is in the shape of a disk to rotate about its own axis when driven. The interference groove 12a is configured for the interference block 11b to be inserted to achieve blocking matching, and may be a groove extending in a radial direction, and a quantity thereof may be one or more.

The holder 13 includes a second block 13a and a first vacancy portion 13b. The holder 13 is detachably connected to the first housing 21. The second block 13a may be an arc-shaped flange, and one end may be hollowed to form the first vacancy portion 13b. A trench 13c may be defined between the second block 13a and the holder 13 for the first block 12b to slide along the second block 13a in the trench 13c. A quantity of second blocks 13a may be one or two. A quantity of first vacancy portions 13b may also be one or two.

In an assembled structure, the extractor 12 is disposed in the second housing 11, and the second housing 11 is switchable between a second position and a third position relative to the extractor 12. The second position may indicate that the top board 11a of the second housing 11 is away from the extractor 12. The third position may indicate that the top board 11a of the second housing 11 is close to the extractor 12. When the second housing 11 is located at the second position relative to the extractor 12, since the top board 11a of the second housing 11 is away from the extractor 12, the interference block 11b is separated from the interference groove 12a. In this case, even if the second housing 11 rotates arbitrarily, the second housing 11 cannot be in interference fit with the extractor 12 of the extractor 12 and thus cannot drive the extractor 12 to rotate. When the second housing 11 is located at the third position relative to the extractor 12, since the top board 11a of the second housing 11 is close to the extractor 12, the interference block 11b is inserted into the interference groove 12a. It is easy to understand that when the interference block 11b is inserted into the interference groove 12a, the second housing 11 may be rotate to drive the extractor 12 to rotate, so that the first block 12b slides along the second block 13a. Therefore, according to the structure of this application, only when the first block 12b moves to be aligned with the first vacancy portion 13b, the second block 13a no longer block and match the first block 12b, so that the second housing 11 together with the extractor 12 can be easily removed from the holder 13. When the second housing 11 is removed, the susceptor 15 can be exposed or a channel that easily accesses to the susceptor 15 can be provided, so that the susceptor 15 can be cleaned.

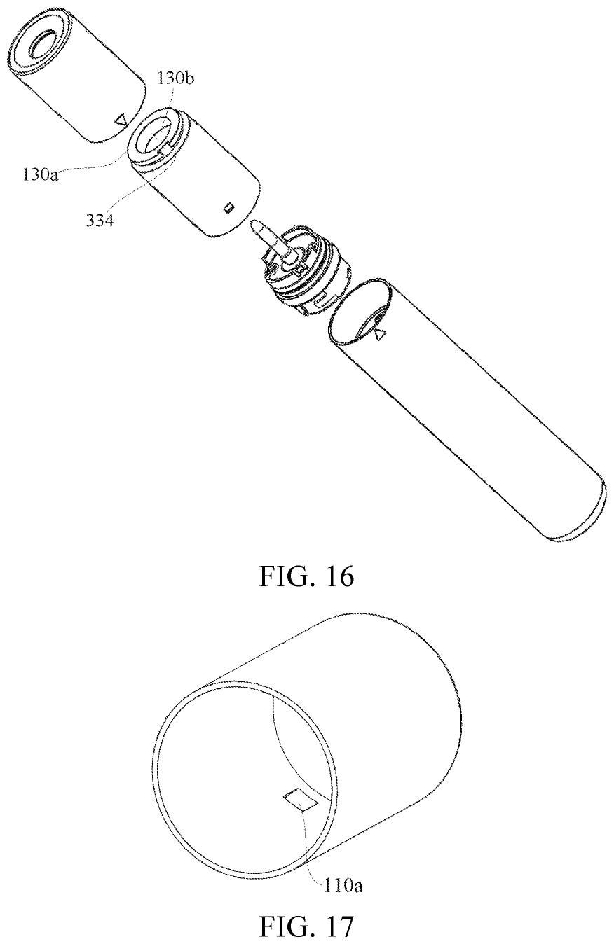

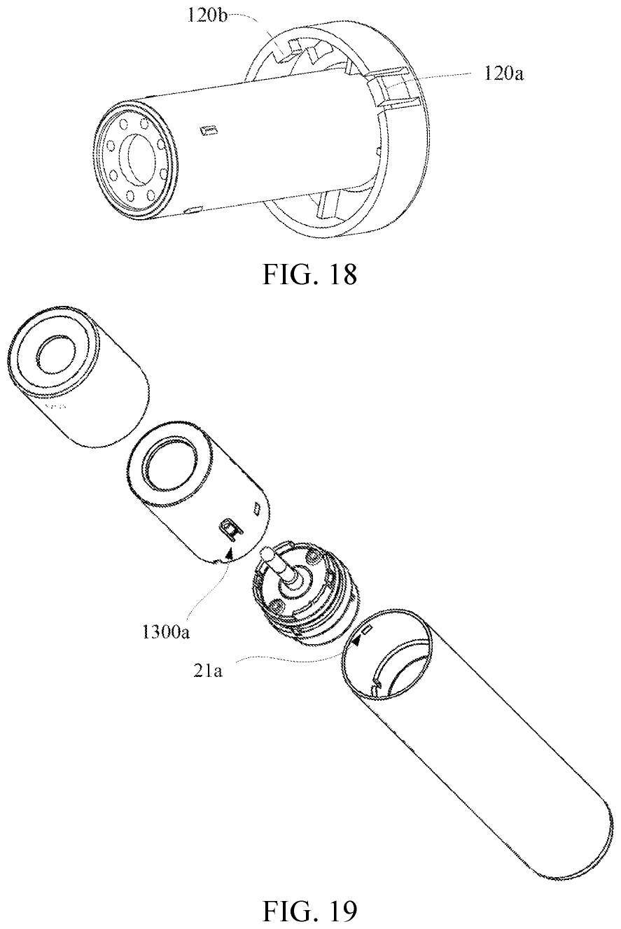

Then, refer to FIG. 16 to FIG. 18. In another example, the anti-mistaken disassembly structure may include a first slot 110a, and the first slot 110a is provided on an inner side of the second housing 11.

A side surface of the extractor 12 is provided with a fourth block 120a, and a bottom side is provided with a first block 120b. A quantity of first slots 110a may be one or two, and a quantity of fourth blocks 120a may be one or two correspondingly. A quantity of first blocks 120b may be one.

The holder 13 includes a second block 130a and a first vacancy portion 130b. The second block 130a may be a substantially circular flange, and one of which is hollowed to form the first vacancy portion 130b. A quantity of first vacancy portions 130b may be one. A trench 130c may be defined between the second block 130a and the holder 13 for the first block 120b to slide along the second block 130a in the trench 130c. The extractor 12 is disposed in the second housing 11, and the fourth block 120a is buckled to the first slot 110a.

In the assembled structure, the extractor 12 may be driven to rotate by rotating the second housing 11, so that the first block 120b slides along the second block 130a. Only when the first block 120b moves to be aligned with the first vacancy portion 130b, the second block 130a no longer block and match the first block 120b, so that the second housing 11 together with the extractor 12 can be easily removed from the holder 13. When the second housing 11 is removed, the susceptor 15 can be exposed or a channel that easily accesses to the susceptor 15 can be provided, so that the susceptor 15 can be cleaned.

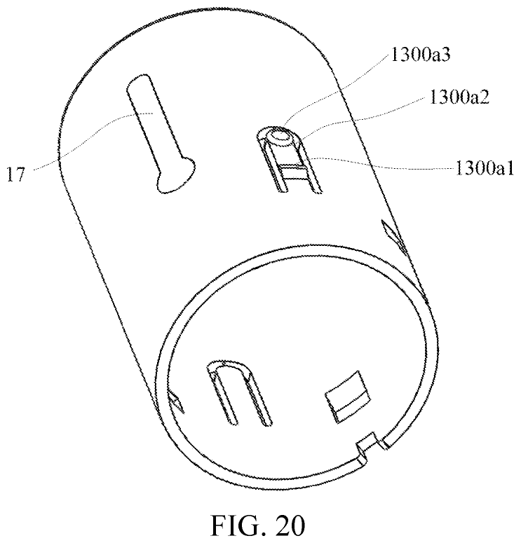

Then, refer to FIG. 19 and FIG. 20. In another example, the anti-mistaken disassembly structure may include a first elastic arm 1300a and a second slot 21a. The first elastic arm 1300a is disposed on a side wall of the holder 13. A first blocking block 1300a1 is disposed on the first elastic arm 1300a. The first blocking block 1300a1 is disposed away from a free end 1300a2 of the first elastic arm 1300a. The second slot 21a is provided on an inner side of the first housing 21, and may be a through hole or a groove. The holder 13 can be partially inserted into the first housing 21, so that the first blocking block 1300a1 is buckled to the second slot 21a, and the free end 1300a2 of the first elastic arm 1300a is located outside the first housing 21.

Refer to FIG. 20. In some exemplary embodiments, to prevent a user from being burned when touching the heating assembly 10, a display element 17 is disposed on the heating assembly 10 or in a region near the heating assembly 10. The display element 17 is configured to feed back a temperature of the heating assembly 10. For example, the display element 17 is disposed on a side wall surface of the holder 13. When the temperature of the heating assembly 10 changes within a specific temperature range, a state of the display element 17 changes. By observing a current state of the display element 17, a current temperature of the heating assembly 10 can be known. The display element 17 changes its own state without external energy supply. The display element 17 and the power supply assembly are insulated from each other, and no current flows between the two. When the temperature of the heating assembly 10 changes, a temperature of the display element 17 also changes, thereby causing changes in an internal structure and causing changes in a display state. The region near the heating assembly 10 includes inner and outer housings and cavities that are disposed close to a heating element. In some examples, the display element 17 may be integrally injection molded with a housing attached to the heating assembly 10.

In some examples, the display element 17 is made of a heat-sensitive material, and the display element 17 may have different color display effects in different temperature ranges. The heat-sensitive material can use a heat-sensitive discoloration material, which is a material whose visible absorption spectrum changes when heated or cooled. Such material has a characteristic that the color changes with the temperature. The temperature at which the color changes occurs is referred to as a discoloration temperature. For example, inorganic reversible thermochromic materials display color changes caused by internal crystalline transformation or changes in lattice constants due to temperature changes, including mixed oxides, iodides, complexes, and double salts of a plurality of metals. The metal and the oxides thereof include:

metals such as copper, silver, and gold, and alloys such as Cu—Zn, Au—Zn, and Ag—Cd. Metal complexes include triphenylmethane metal complexes, organic amine or ammonium metal complexes. The ligand may be a metal complex of organic ions. Inorganic reversible thermochromic materials have good temperature resistance, durability, and good mixing processability. A synthesis process is simple and the cost is low. In some embodiments, the metal complex may change from a first color to a second color when the temperature is 40 degrees Celsius, 50 degrees Celsius, 60 degrees Celsius, or 70 degrees Celsius.

In some embodiments, the heat-sensitive material can be added to the plastic particles as a color masterbatch additive. The plastic particles are preferably transparent or translucent materials, including polypropylene, soft polyvinyl chloride, AS, ABS, and silica gel. The color-changing additive is added to the plastic particles, mix thoroughly, and injection mold the display element 17. In some embodiments, the display element 17 may be designed in the shape of a thermometer, which allows the user to quickly identify the correlation between the display element 17 and the temperature, and facilitates prompting the user of a current temperature status of the heating assembly 10. It may be understood that the display element 17 may alternatively be in any shape, as long as an eye-catching effect is generated. When the holder 13 needs to be removed, the free end 1300a2 of the first elastic arm 1300a may be pressed into the holder 13 to release a buckling connection between the first blocking block 1300a1 and the second slot 21a, so that the holder 13 can be removed from the first housing 21. When the holder 13 is removed, the susceptor 15 may be exposed, so that the susceptor 15 can be cleaned.

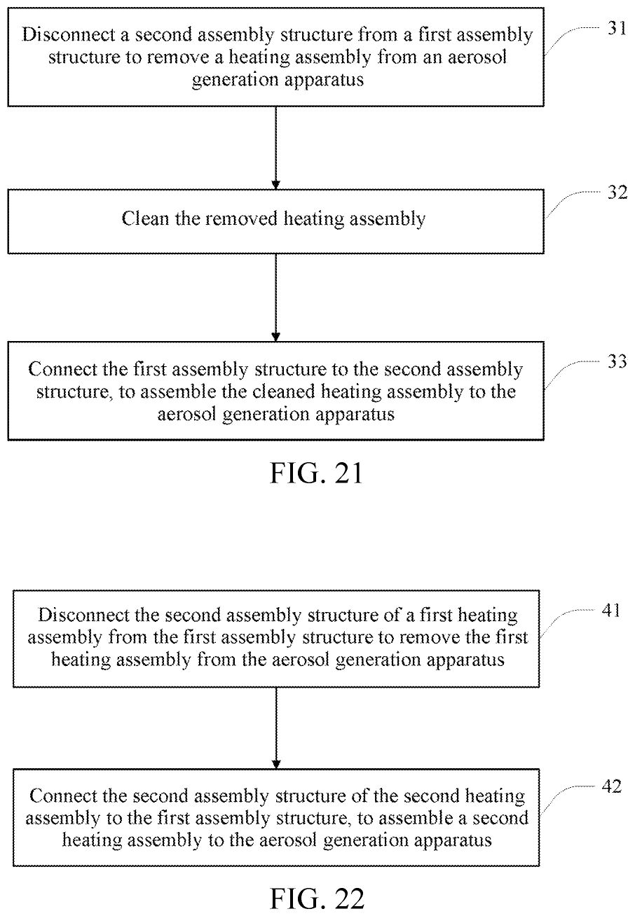

Another aspect in this application provides a method for an aerosol-generation device. The aerosol-generation device includes a first assembly structure and the heating assembly, where the heating assembly has a second assembly structure matching the first assembly structure, Refer to FIG. 21. The method includes:

Step 31: Disconnect a second assembly structure from a first assembly structure to remove a heating assembly from an aerosol-generation device.

Step 32: Clean the removed heating assembly.

Step 33: Connect the first assembly structure to the second assembly structure, to assemble the cleaned heating assembly to the aerosol-generation device.

Another aspect in this application provides a method for an aerosol-generation device. The aerosol-generation device includes a first assembly structure and the heating assembly, where there are two heating assemblies, namely, a first heating assembly and a second heating assembly, where the first heating assembly and the second heating assembly each include a second assembly structure matching the first assembly structure. Refer to FIG. 22. The method includes:

Step 41: Disconnect the second assembly structure of a first heating assembly from the first assembly structure to remove the first heating assembly from the aerosol-generation device.

Step 42: Connect the second assembly structure of the second heating assembly to the first assembly structure, to assemble a second heating assembly to the aerosol-generation device.

It should be noted that, for the first assembly structure and the second assembly structure, refer to the foregoing detachable connection structure, for example, the buckling connection and the screw-lock connection. Specifically, details are not described herein.

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on content of this application, and are provided for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or modifications according to the foregoing description, and all the improvements and modifications shall fall within the protection scope of the attached claims of this application.

1. A heating assembly, wherein the heating assembly is detachably disposed on an aerosol-generation device; and the heating assembly comprises:
a susceptor, configured to be penetrated by a changing magnetic field to generate heat, to heat an aerosol-generation product;
a keeping member, configured to keep the susceptor; and
a first electrical connector, wherein one end is configured to be electrically connected to a power supply assembly in the aerosol-generation device, and an other end is configured to be electrically connected to a magnetic field generator in the aerosol-generation device.

2. The heating assembly according to claim 1, wherein the first electrical connector is disposed in the keeping member.

3. The heating assembly according to claim 1, wherein the keeping member has a first surface and a second surface opposite to the first surface; and
the end of the electrical connector is exposed on the first surface, and the other end is exposed on the second surface.

4. The heating assembly according to claim 1, wherein the keeping member comprises a base and a fixing base that are detachably connected; and
the base is fixedly connected to the susceptor, and the fixing base is configured to keep the base.

5. (canceled)

6. (canceled)

7. The heating assembly according to claim 1, further comprising a temperature measuring element and a second electrical connector wherein
the temperature measuring element is configured to sense temperature information of the susceptor; and
the end of the second electrical connector is electrically connected to the temperature measuring element, and the other end is configured to be electrically connected to the power supply assembly in the aerosol-generation device;
wherein the temperature measuring element is at least partially disposed in the susceptor.

8. (canceled)

9. An aerosol-generation device, comprising:
a power supply assembly, comprising a first housing, wherein the power supply assembly is configured to supply power;
a magnetic field generator, configured to generate a changing magnetic field;
the healing assembly according to claim 1; and further comprising a holder, configured to hold the magnetic field generator, wherein
the holder is detachably connected to the keeping member.

10. The aerosol-generation device according to claim 9, further comprising a third electrical connector disposed on the holder, wherein
one end of the third electrical connector is electrically connected to the magnetic field generator; and when the holder is connected to the keeping member, an other end is configured to be in contact with the first electrical connector to form an electrical connection.

11. The aerosol-generation device according to claim 9, wherein the holder comprises an inner cylinder and an outer cylinder, and the magnetic field generator is kept between the inner cylinder and the outer cylinder.

12. The aerosol-generation device according to claim 11, wherein the inner cylinder is detachably connected to the outer cylinder.

13. (canceled)

14. The aerosol-generation device according to claim 1312, wherein an inner wall of the outer cylinder is provided with a groove, and an outer wall of the inner cylinder has a first convex buckle snap-fitted to groove, and the first convex buckle is a cantilever formed on the outer wall of the inner cylinder.

15. The aerosol-generation device according to claim 11, wherein an axial extension length of the outer cylinder is greater than an axial extension length of the inner cylinder, to form an accommodating chamber between an end portion of the outer cylinder and an end portion of the inner cylinder; and
when the keeping member is connected to the holder, at least part of the keeping member is accommodated in the accommodating chamber.

16. The aerosol-generation device according to claim 11, wherein the keeping member is detachably connected to the outer cylinder.

17. The aerosol-generation device according to claim 16, wherein the inner wall of the outer cylinder is provided with a first engagement hole, and an outer wall of the keeping member has a second convex buckle snap-fitted to the first engagement hole.

18. The aerosol-generation device according to claim 9, further comprising an extractor configured to extract the aerosol-generation product received in a heating chamber, wherein the extractor is detachably connected to the holder.

19. (canceled)

20. The aerosol-generation device according to claim 18, further comprising a second housing that is detachably connected to the holder and the extractor, and a first anti-mistaken disassembly structure, wherein the second housing is detachably connected to the extractor and the holder through the first anti-mistaken disassembly structure.

21. (canceled)

22. The aerosol-generation device according to claim 19, wherein the holder is detachably connected to the first housing, the healing assembly further comprises a second anti-mistaken disassembly structure, wherein the holder is detachably connected to the first housing through the second anti-mistaken disassembly structure.

23. (canceled)

24. The aerosol-generation device according to claim 9, wherein a clamping portion is disposed inside the first housing; and
the heating assembly has an interface, configured to be screw-locked with the clamping portion.

25. The aerosol-generation device according to claim 9, wherein the first housing is provided with a second engagement hole; and
the heating assembly has an elastic arm, configured to be buckled to the second engagement hole.

26. The aerosol-generation device according to claim 25, further comprising a moving member, configured to move toward the elastic arm under the action of an external force, to disengage the elastic arm from the second engagement hole.

27. The aerosol-generation device according to claim 26, further comprising an elastic member connected to the moving member, wherein
the elastic member is configured to generate a repulsive force under the action of the external force, so that the moving member returns to an initial position.

28. (canceled)

29. (canceled)

30. (canceled)
